(19) United States
(12) Patent Application Publication
(10) Pub. No.: US 2026/0122429 A1
(43) Pub. Date: Apr. 30, 2026

(54) Audio Processing Method, Hearing Aid Device, and Hearing Aid System

(71) Applicant: Anker Innovations Technology Co., Ltd., Changsha (CN)

(72) Inventors: Xianpeng Ling, Shenzhen (CN); Guochang Zhang, Shenzhen (CN); Jianqiang Wei, Shenzhen (CN)

(21) Appl. No.: 19/369,506

(22) Filed: Oct. 27, 2025

(30) Foreign Application Priority Data
Oct. 28, 2024 (CN) 202411518316.X

(51) Int. Cl. H04R 25/00

(52) U.S. Cl. CPC H04R 25/407; H04R 25/405; H04R 25/505

(57) ABSTRACT

An audio processing method, device, and system for adjusting the sound pickup direction of a device is disclosed. The method comprises: acquiring each channel of an audio frequency-domain signals of each microphone in two microphone arrays; receiving sound pickup direction indication information; determining a sound pickup suppression direction according to the sound pickup direction indication information; and adjusting a signal amplitude of each of the channels of the audio frequency-domain signal to obtain a first and second directionally enhanced audio signals. The first directionally enhanced audio signal is output through the first hearing aid unit, and the second directionally enhanced audio signal is output through the second hearing aid unit. Two microphone arrays are respectively located on the first hearing aid unit and the second hearing aid unit.

### CROSS-REFERENCE TO RELATED APPLICATION

The present disclosure claims priority to CN Application No. 202411518316.X, filed on Oct. 28, 2024. The above application is hereby incorporated in its entirety.

### FIELD

The present disclosure relates to the technical field of audio processing, particularly to an audio processing method, a hearing aid device, and a hearing aid system.

### BACKGROUND

A hearing aid device is an electronic device for picking up an audio signal in the environment and performing directional enhancement on the audio signal to obtain an enhanced audio signal. Earphones and hearing aids common in life may be referred to as hearing aid devices.

In the related art, the hearing aid devices are constrained by algorithms employed, and are only capable of implementing signal enhancement in a fixed direction, thereby reducing quality of the processed audio signal.

### SUMMARY

It is desirable to provide an audio processing method, a hearing aid device, and a hearing aid system for the above technical problem.

In a first aspect, the disclosure provides an audio processing method applied to a hearing aid device including a first hearing aid unit and a second hearing aid unit, the method comprising: acquiring one or more channels of an audio frequency-domain signal of each microphone in two microphone arrays that are respectively located on the first hearing aid unit and the second hearing aid unit; receiving sound pickup direction indication information; determining a sound pickup suppression direction according to the sound pickup direction indication information; adjusting, based on the sound pickup suppression direction, a signal amplitude of each of the one or more channels of the audio frequency-domain signal to obtain a first directionally enhanced audio signal and a second directionally enhanced audio signal; and outputting the first directionally enhanced audio signal through the first hearing aid unit and the second directionally enhanced audio signal through the second hearing aid unit.

In an example, adjusting the signal amplitude of each of the one or more channels of the audio frequency-domain signal to obtain the first directionally enhanced audio signal and the second directionally enhanced audio signal includes: extracting features of each of the one or more channels of the audio frequency-domain signal to obtain feature information; inputting the feature information and the sound pickup suppression direction into a signal enhancement model; and performing signal processing on each channel of the audio frequency-domain signal through the signal enhancement model to obtain the first directionally enhanced audio signal and the second directionally enhanced audio signal, the signal enhancement model being a pre-trained neural network model.

In an example, adjusting the signal amplitude of each of the one or more channels of the audio frequency-domain signal to obtain the first directionally enhanced audio signal and the second directionally enhanced audio signal includes: performing fusion processing on the one or more channels of the audio frequency-domain signal of the first hearing aid unit to obtain a fused first frequency-domain signal; performing fusion processing on the one or more channels of the audio frequency-domain signal of the second hearing aid unit to obtain a fused second frequency-domain signal; and performing signal amplitude suppression in the sound pickup suppression direction on the fused first frequency-domain signal and the fused second frequency-domain signal separately to obtain the first directionally enhanced audio signal and the second directionally enhanced audio signal.

In an example, the feature information includes an amplitude difference feature and a phase difference feature; and extracting features of each channel of the audio frequency-domain signal to obtain feature information includes: extracting phase information of each of the one or more channels of the audio frequency-domain signal of each microphone in a microphone array of a same hearing aid unit to obtain the phase difference feature; and extracting amplitude information of each of the one or more channels of the audio frequency-domain signal of each microphone in microphone arrays of different hearing aid units, to obtain the amplitude difference feature.

In an example, each of the two microphone arrays includes two microphones; and extracting phase information of each of the one or more channels of the audio frequency-domain signal of each microphone in a microphone array of a same hearing aid unit to obtain the phase difference feature includes: acquiring a phase difference between two channels of audio frequency-domain signals of the first hearing aid unit as a first feature; acquiring a phase difference between two channels of audio frequency-domain signals of the second hearing aid unit as a second feature; and taking the first feature and the second feature as the phase difference feature.

In an example, each of the microphone arrays includes two microphones; and extracting amplitude information of each of the one or more channels of the audio frequency-domain signal of each microphone in the two microphone arrays of different hearing aid units to obtain the amplitude difference feature includes: acquiring a first average amplitude at a same frequency point between two channels of audio frequency-domain signals of the first hearing aid unit, and a second average amplitude at a same frequency point between two channels of audio frequency-domain signals of the second hearing aid unit; and acquiring an amplitude difference between the first average amplitude and the second average amplitude at the same frequency point as the amplitude difference feature.

In an example, performing signal amplitude suppression in the sound pickup suppression direction on the first frequency-domain signal and the second frequency-domain signal separately to obtain the first directionally enhanced audio signal and the second directionally enhanced audio signal includes: acquiring a phase at each frequency point of the first frequency-domain signal and the second frequency-domain signal; and performing signal amplitude suppression on the first frequency-domain signal and the second frequency-domain signal according to the phase at each frequency point of the first frequency-domain signal and the second frequency-domain signal and the sound pickup suppression direction to obtain the first directionally enhanced audio signal and the second directionally enhanced audio signal.

In an example, performing signal amplitude suppression on the first frequency-domain signal and the second frequency-domain signal according to the phase at each frequency point of the first frequency-domain signal and the second frequency-domain signal and the sound pickup suppression direction to obtain the first directionally enhanced audio signal and the second directionally enhanced audio signal includes: reducing a signal amplitude of a frequency point signal where phases of the first frequency-domain signal and the second frequency-domain signal match the sound pickup suppression direction, and/or, increasing a signal amplitude of a frequency point signal where phases of the first frequency-domain signal and the second frequency-domain signal do not match the sound pickup suppression direction, to obtain a first directionally enhanced frequency-domain signal and a second directionally enhanced frequency-domain signal; and performing time-frequency transformation on the first directionally enhanced frequency-domain signal and the second directionally enhanced frequency-domain signal separately, to obtain the first directionally enhanced audio signal and the second directionally enhanced audio signal.

In a second aspect, the disclosure further provides a hearing aid device including a first hearing aid unit, a second hearing aid unit, and a control chip, either of the first hearing aid unit and the second hearing aid unit including a microphone array and a loudspeaker, in which the control chip is configured to implement the steps of the method of any one of any one of the above audio processing methods.

In an example, the disclosure further provides a hearing aid system including an input terminal and a hearing aid device that communicate with each other, in which the input terminal is configured to send sound pickup direction indication information to the hearing aid device, and the hearing aid device is configured to implement the steps of any one of the above audio processing methods.

In the above audio processing method, hearing aid device, and hearing aid system, the method includes: acquiring one or more channels of an audio frequency-domain signal of each microphone in two microphone arrays; receiving sound pickup direction indication information; determining a sound pickup suppression direction according to the sound pickup direction indication information; and adjusting, based on the sound pickup suppression direction, a signal amplitude of each of the one or more channels of the audio frequency-domain signal to obtain a first directionally enhanced audio signal and a second directionally enhanced audio signal. The first directionally enhanced audio signal is played through the first hearing aid unit, and the second directionally enhanced audio signal is played through the second hearing aid unit; and the two microphone arrays are respectively located on the first hearing aid unit and the second hearing aid unit. In the above method, the sound pickup suppression direction can be determined based on the received sound pickup direction indication information, and signal amplitude adjustment is performed according to the sound pickup suppression direction, thereby realizing adjustment of the sound pickup direction of a device. A user can flexibly adjust the sound pickup direction based on actual needs, thus improving directionality and flexibility of audio processing, and correspondingly improving quality of the processed audio signal.

### BRIEF DESCRIPTION OF THE DRAWINGS

FIG. 1 is a structure diagram of a hearing aid device according to an example;

FIG. 2 is a schematic flowchart of an audio processing method according to an example;

FIG. 3 is an interface operation diagram in which sound pickup indication information is input according to an example;

FIG. 4(a) is a schematic distribution diagram of a sound pickup direction according to an example;

FIG. 4(b) is a schematic distribution diagram of a sound pickup direction according to another example;

FIG. 5 is a schematic flowchart of obtaining a first directionally enhanced audio signal and a second directionally enhanced audio signal according to an example;

FIG. 6 is a schematic flowchart of obtaining a first directionally enhanced audio signal and a second directionally enhanced audio signal according to another example;

FIG. 7 is a schematic flowchart of determining feature information according to an example;

FIG. 8 is a schematic flowchart of determining a phase difference feature according to an example;

FIG. 9 is a schematic flowchart of determining an amplitude difference feature according to an example;

FIG. 10 is a schematic flowchart of obtaining a first directionally enhanced audio signal and a second directionally enhanced audio signal according to another example;

FIG. 11 is a schematic flowchart of obtaining a first directionally enhanced audio signal and a second directionally enhanced audio signal according to another example;

FIG. 12 is a schematic flowchart of an audio processing method according to another example;

FIG. 13 is a graphical diagram of an audio processing method according to an example;

FIG. 14 is a structure diagram of a neural network according to an example; and

FIG. 15 is a structure block diagram of an audio processing device according to an example.

### DETAILED DESCRIPTION

In order to make the object, technical solutions, and advantages of the present disclosure clearer and easier to understand, further detailed description of the present disclosure is made with reference to accompanying drawings and examples below. It can be understood that the specific examples described herein are merely for explaining the present disclosure and are not for limiting the present disclosure.

An example audio processing method is provided in the present disclosure, and is applied to a hearing aid device including a first hearing aid unit and a second hearing aid unit. Therefore, before a process of the audio processing method is described in detail, the hearing aid device provided in the example of the present disclosure is described first.

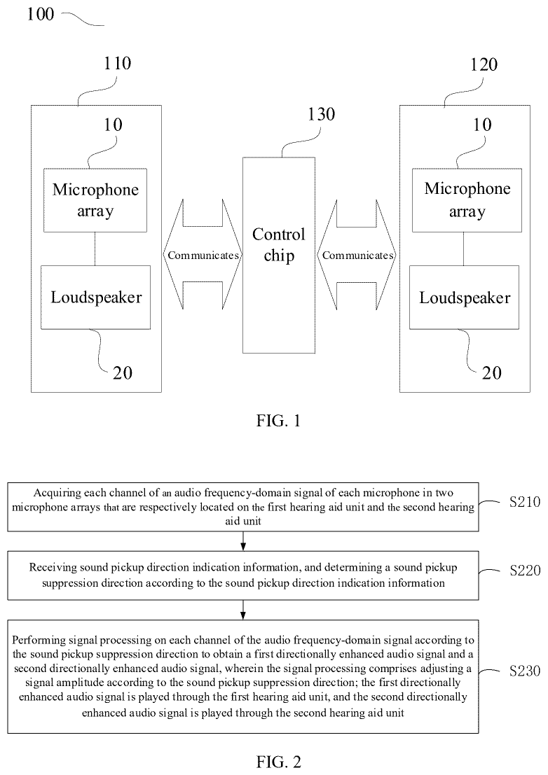

In an example, as shown in FIG. 1, a hearing aid device 100 is provided, including: a first hearing aid unit 110, a second hearing aid unit 120, and a control chip 130; either of the first hearing aid unit 110 and the second hearing aid unit 120 includes a microphone array 10 and a loudspeaker 20. The control chip 130 communicates with either and/or both of the first hearing aid unit 110 and the second hearing aid unit 120.

In some instances, the hearing aid device 100 may be a hearing aid, or an earphone that supports a hearing aid function. In some examples, the hearing aid device 100 is a separate-type device in a separate form, such as an in-ear or ear-hook earphone, or a hearing aids worn on left and right ears respectively, or is an integral-type device in an integral form, such as a head-mounted earphone, or a helmet to which virtual reality technology (VR) is applied.

In a case where the hearing aid device 100 is a separate-type device, the control chip 130 may be disposed in either of the first hearing aid unit 110 or the second hearing aid unit 120, and in some examples is disposed by default in a hearing aid unit used on a right side. In a case where the hearing aid device 100 is the integral-type device, the control chip 130 may be disposed at any position of the integral-type device, for example, disposed by default in a middle connection region of the head-mounted earphone, or disposed by default in a top region of the VR helmet.

Each microphone array 10 includes at least two microphones independent of each other and disposed at different positions to collect sound signals in different directions. When a user wears the hearing aid device 100, the first hearing aid unit 110 and the second hearing aid unit 120 are respectively located on a left ear side and a right ear side, and correspondingly the two microphone arrays 10 are respectively located on the left ear side and the right ear side, and are capable of collecting multi-channel sound signals on the left ear side, and multi-channel sound signals on the right ear side respectively.

The microphone is configured to convert a collected sound signal into an electrical signal for the control chip 130 to perform signal processing. The microphone array 10 including at least two microphones may collecting at least two channels of sound signals and send electrical signals obtained by converting the collected at least two channels of sound signals to the control chip 130 for signal processing.

The control chip 130 is configured to process the electrical signals of each channel of sound signal collected by the microphone array 10, and sending the processed electrical signals to the loudspeaker 20.

Each channel of sound signal collected by the microphone array 10 in the first hearing aid unit 110 corresponds to a sound signal obtained by the first hearing aid unit 110, and each channel of sound signal collected by the microphone array 10 in the second hearing aid unit 120 corresponds to a sound signal obtained by the second hearing aid unit 120.

The control chip 130 is further configured to receive sound pickup direction indication information sent by an external terminal, and determining a sound pickup suppression direction according to the sound pickup direction indication information. The signal processing correspondingly includes adjusting a signal amplitude according to the sound pickup suppression direction to achieve audio directional enhancement. In some examples, the above signal processing may further include processing such as time-frequency transformation, filtering noise reduction, or signal fusion of the sound signal.

The loudspeaker 20 is configured to convert an electrical signal into a sound signal to play. The control chip 130 sends each channel of processed electrical signal to the loudspeaker 20, and the loudspeaker 20 converts each channel of processed electrical signal into a sound signal to play.

Two loudspeakers 20 are also respectively located on the left ear side and the right ear side. The loudspeaker 20 in the first hearing aid unit 110 may play a first directionally enhanced audio signal obtained based on the sound signal obtained by the first hearing aid unit 110; and the loudspeaker 20 in the second hearing aid unit 120 may play a second directionally enhanced audio signal obtained based on the sound signal obtained by the second hearing aid unit 120.

Next, the audio processing method provided by the example of the present disclosure is introduced in detail. For example, the method is applied to the hearing aid device in FIG. 1, specifically to the control chip in the hearing aid device. In an example, as shown in FIG. 2, an audio processing method is provided.

S210 comprises acquiring each channel of an audio frequency-domain signal of each microphone in two microphone arrays that are respectively located on the first hearing aid unit and the second hearing aid unit. The audio frequency-domain signal of the microphone may be a frequency-domain signal obtained by transforming a sound signal (e.g., an audio signal) collected by the microphone from a time domain to a frequency domain.

In some instances, the control chip respectively receives audio signals collected by each microphone in the microphone arrays of the first hearing aid unit and the second hearing aid unit, and performs short-time Fourier transform (STFT) on each channel of the audio signal to transform the audio signal from the time domain to the frequency domain to obtain each channel of an audio frequency-domain signal. In some examples, in a case where each microphone array includes two microphones, the control chip may perform transformations to obtain two channels of audio frequency-domain signals corresponding to the first hearing aid unit, and two channels of audio frequency-domain signals corresponding to the second hearing aid unit.

S220 comprises receiving sound pickup direction indication information, and determining a sound pickup suppression direction according to the sound pickup direction indication information.

The sound pickup direction indication information may be determined based on a user's selection operation, which may be a sound pickup suppression direction or a sound pickup enhancement direction. In some examples, the sound pickup direction information may be represented by an angle, where a sound pickup direction that the hearing aid device may cover is usually a range of 360° with the hearing aid device as a center, and a sum of an angle range of the sound pickup suppression direction and an angle range of the sound pickup enhancement direction is 360°. Therefore, in a case where one of the two angle ranges is known, the other angle range can be derived. For example, when the sound pickup suppression direction is 45° to 135°, the sound pickup enhancement direction is 135° to 45°.

The hearing aid device may communicate with an input terminal. The user may input a control command to a binaural hearing aid device through the input terminal to control a working state of the hearing aid device. The input control command includes a sound pickup control command for adjusting a sound pickup direction of the hearing aid device, and the sound pickup control command carries the sound pickup direction indication information. The control chip in the hearing aid device may receive the sound pickup control command sent by the input terminal, and parsing the sound pickup control command to obtain the sound pickup direction indication information carried in the sound pickup control command.

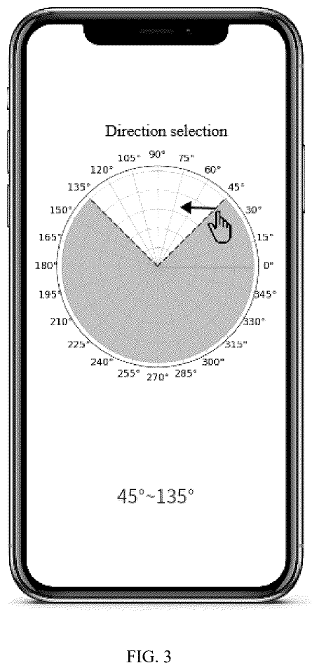

In some cases where the input terminal is a mobile terminal such as a mobile phone, the user may log into an application (APP) associated with the hearing aid device through a mobile phone terminal, and enter a sound pickup direction selection interface. As shown in FIG. 3, the user may select the sound pickup enhancement direction on a direction selection interface. The example in FIG. 3 shows that the user selects a direction of 45° to 135° as the sound pickup enhancement direction. After the user completes the selection, the mobile phone terminal takes the sound pickup enhancement direction selected by the user as the sound pickup direction indication information, generates the sound pickup control command carrying the sound pickup direction indication information, and sends the sound pickup control command to the hearing aid device.

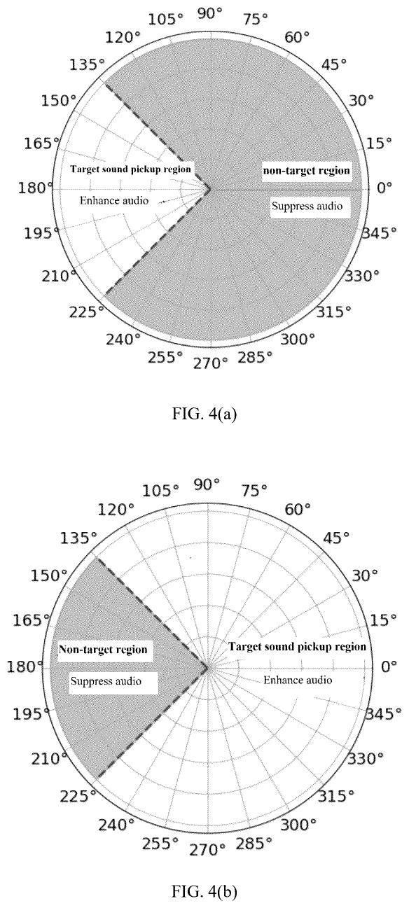

In some instances, the sound pickup enhancement direction corresponds to a target sound pickup region of the hearing aid device, and the sound pickup suppression direction corresponds to a non-target sound pickup region of the hearing aid device. The control chip may, by processing each channel of the audio frequency-domain signal, achieve a processing effect of enhancing voice in the target sound pickup region and suppressing voice in the non-target sound pickup region. In some examples, as shown in FIG. 4(a) and FIG. 4(b), a shaded region is a non-target sound pickup region where audio needs to be enhanced; and a non-shaded region is a target sound pickup region where audio needs to be suppressed.

In some cases where the sound pickup direction indication information is the sound pickup suppression direction selected by the user, the control chip may directly obtain the sound pickup suppression direction from the sound pickup indication information. Alternatively, in a case where the sound pickup direction indication information is the sound pickup enhancement direction selected by the user, the control chip may conversely obtain the sound pickup suppression direction from the sound pickup enhancement direction in the sound pickup indication information.

S230 comprises performing signal processing on each channel of the audio frequency-domain signal according to the sound pickup suppression direction to obtain a first directionally enhanced audio signal and a second directionally enhanced audio signal. The signal processing may include adjusting a signal amplitude according to the sound pickup suppression direction. The first directionally enhanced audio signal is played through the first hearing aid unit, and the second directionally enhanced audio signal is played through the second hearing aid unit.

In some instances, after obtaining each channel of the audio frequency-domain signal and the sound pickup direction indication information, the control chip can perform different signal amplitude adjustments on each channel of the audio frequency-domain signal according to the sound pickup suppression direction. In some examples, the control chip may reduce a signal amplitude corresponding to the sound pickup suppression direction in each channel of the audio frequency-domain signal according to the sound pickup suppression direction, or may increase a signal amplitude corresponding to a non-sound pickup suppression direction in each channel of the audio frequency-domain signal according to the sound pickup suppression direction.

In some instances, the control chip may further process a directionally enhanced audio frequency-domain signal after amplitude adjustment to obtain two channels of directionally enhanced audio signals, which are the first directionally enhanced audio signal and the second directionally enhanced audio signal. In some examples, the microphone array in the first hearing aid unit and the second hearing aid unit includes two microphones. The control chip may correspondingly obtain two channels of directionally enhanced audio frequency-domain signals after amplitude adjustment corresponding to the first hearing aid unit, and two channels of directionally enhanced audio frequency-domain signals after amplitude adjustment corresponding to the second hearing aid unit. The control chip may perform filtering noise reduction and inverse short-time Fourier transform (ISTFT) on the four channels of signals to transform the four channels of signals from the frequency domain to the time domain and obtain four channels of directionally enhanced audio signals, and then further process the four channels of directionally enhanced audio signals to obtain the first directionally enhanced audio signal and the second directionally enhanced audio signal, which are respectively played through the first hearing aid unit and the second hearing aid unit.

Continuing the above example, the control chip may, in two channels of directionally enhanced audio signals corresponding to each hearing aid unit, select one channel as an output, or output a weighted fusion of the two channels, to obtain one channel of directionally enhanced audio signal, and the two hearing aid units correspondingly obtain two channels of directionally enhanced audio signals, which are the first directionally enhanced audio signal and the second directionally enhanced audio signal.

In some instances, after the first directionally enhanced audio signal and the second directionally enhanced audio signal are obtained, the control chip may play the first directionally enhanced audio signal to a left ear through the loudspeaker in the first hearing aid unit, and play the second directionally enhanced audio signal to a right ear through the loudspeaker in the second hearing aid unit.

In an example of the present disclosure, by acquiring the audio frequency-domain signal of each microphone in the two microphone arrays respectively located on the first hearing aid unit and the second hearing aid unit, receiving the sound pickup direction indication information, and determining the sound pickup suppression direction according to the sound pickup direction indication information, signal processing is performed on each channel of the audio frequency-domain signal according to the sound pickup suppression direction to obtain the first directionally enhanced audio signal and the second directionally enhanced audio signal. The signal processing includes performing signal amplitude adjustment according to the sound pickup suppression direction. The first directionally enhanced audio signal is played through the first hearing aid unit, and the second directionally enhanced audio signal is played through the second hearing aid unit. In the above method, the sound pickup suppression direction is determined based on the received sound pickup direction indication information, and signal amplitude adjustment is performed according to the sound pickup suppression direction, thereby realizing adjustment of the sound pickup direction of a device. The user may flexibly adjust the sound pickup direction based on actual needs, thus improving directionality and flexibility of audio processing, and correspondingly improving quality of the processed audio signal.

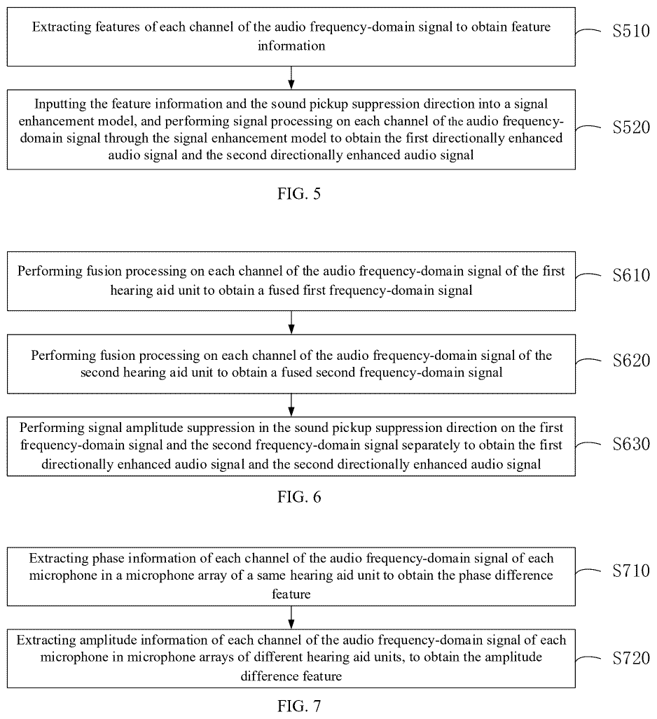

To obtain the first directionally enhanced audio signal and the second directionally enhanced audio signal, in an example, as shown in FIG. 5, the step S230 of performing signal processing on each channel of the audio frequency-domain signal according to the sound pickup suppression direction to obtain the first directionally enhanced audio signal and the second directionally enhanced audio signal may comprise steps S510 and S520.

S510 comprises extracting features of each channel of the audio frequency-domain signal to obtain feature information. The feature information may be phase, amplitude or frequency, or information determined based on phase, amplitude or frequency, such as phase difference, amplitude difference, or frequency difference.

In some instances, the control chip may perform feature extraction on each channel of the audio frequency-domain signal to obtain the feature information of each channel of the audio frequency-domain signal, such as extracting a phase and an amplitude of each channel of the audio frequency-domain signal as the feature information of the corresponding audio frequency-domain signal. The control chip may also further process the phase and amplitude of each extracted audio frequency-domain signal to obtain the feature information. In some examples, the control chip may acquire a phase difference of audio frequency-domain signals of a same hearing aid unit, and an amplitude difference between audio frequency-domain signals of different hearing aid units, and take the phase difference and the amplitude difference as the feature information.

S520 comprises inputting the feature information and the sound pickup suppression direction into a signal enhancement model, and perform signal processing on each channel of the audio frequency-domain signal through the signal enhancement model to obtain the first directionally enhanced audio signal and the second directionally enhanced audio signal. The signal enhancement model may be a pre-trained neural network model. In some examples, the signal enhancement model may be a convolutional neural network (CNN) model.

In some instances, after obtaining the feature information and the sound pickup suppression direction, the control chip may input the feature information and the sound pickup suppression direction into the signal enhancement model. The signal enhancement model may perform processing such as signal amplitude suppression, noise reduction, fusion, and time-frequency transformation on each channel of the audio frequency-domain signal to obtain the first directionally enhanced audio signal and the second directionally enhanced audio signal.

In some instances, the signal enhancement model is trained based on multi-channel audio signals with noise collected by the hearing aid device. The signal enhancement model takes the feature information and the sound pickup suppression direction of the multi-channel audio signals with noise as model training inputs to obtain two channels of audio signals with audio amplitudes in the sound pickup suppression direction suppressed (e.g., directionally enhanced pure audio signals) as model training targets. A model training process may use a compressed complex spectral distance loss function to constrain an output and a target of the model, and perform gradient update on model parameters with an Adam optimizer.

By extracting features of each channel of the audio frequency-domain signal to obtain the feature information, the feature information and the sound pickup suppression direction are input into the signal enhancement model, and signal processing may be performed on each channel of the audio frequency-domain signal through the signal enhancement model to obtain the first directionally enhanced audio signal and the second directionally enhanced audio signal. In the above method, the signal processing including performing signal amplitude adjustment according to the sound pickup suppression direction is performed on each channel of the audio frequency-domain signal based on the feature information through the signal enhancement model to obtain the directionally enhanced first directionally enhanced audio signal and second directionally enhanced audio signal. The signal enhancement model is obtained by training a large number of samples, is accurate and reliable, and may correspondingly improve reliability of signal processing and synchronously improve signal quality of the processed first directionally enhanced audio signal and second directionally enhanced audio signal.

In an example, as shown in FIG. 6, the step S520 of performing signal processing on each channel of the audio frequency-domain signal to obtain the first directionally enhanced audio signal and the second directionally enhanced audio signal may comprise steps S610-S630.

S610 comprises performing fusion processing on each channel of the audio frequency-domain signal of the first hearing aid unit to obtain a fused first frequency-domain signal. The acquired each channel of the audio frequency-domain signal includes each channel of the audio frequency-domain signal from the first hearing aid unit, and each channel of the audio frequency-domain signal from the second hearing aid unit.

In some instances, the control chip may, in each channel of the audio frequency-domain signal, determine each channel of the audio frequency-domain signal corresponding to the first hearing aid unit, and perform fusion on each channel of the audio frequency-domain signal of the first hearing aid unit to obtain the fused first frequency-domain signal.

S620 comprises performing fusion processing on each channel of the audio frequency-domain signal of the second hearing aid unit, to obtain a fused second frequency-domain signal.

In some instances, same as a method for acquiring the first frequency-domain signal, the control chip may, in each channel of the audio frequency-domain signal, determine each channel of the audio frequency-domain signal corresponding to the second hearing aid unit, and fuse each channel of the audio frequency-domain signal of the second hearing aid unit to obtain the fused second frequency-domain signal.

S630 comprises performing signal amplitude suppression in the sound pickup suppression direction on the first frequency-domain signal and the second frequency-domain signal separately to obtain the first directionally enhanced audio signal and the second directionally enhanced audio signal.

In some instances, for the fused first frequency-domain signal and second frequency-domain signal, the control chip may determine a signal distribution direction based on a phase of the audio frequency-domain signal to suppress a signal amplitude in the sound pickup suppression direction of the first frequency-domain signal and the second frequency-domain signal, and to respectively obtain the first directionally enhanced audio signal and the second directionally enhanced audio signal. In some examples, the control chip may reduce the signal amplitude in the sound pickup suppression direction to 0, or reduce the signal amplitude to 50% of an original signal amplitude, to realize the signal amplitude suppression.

In the example of the present disclosure, fusion processing is performed on each channel of the audio frequency-domain signal of the first hearing aid unit to obtain the fused first frequency-domain signal; and fusion processing is performed on each channel of the audio frequency-domain signal of the second hearing aid unit to obtain the fused second frequency-domain signal, to separately perform signal amplitude suppression in the sound pickup suppression direction on the first frequency-domain signal and the second frequency-domain signal to obtain the first directionally enhanced audio signal and the second directionally enhanced audio signal. In the above method, the signal amplitude suppression in the corresponding sound pickup suppression direction is performed based on the sound pickup suppression direction, thereby realizing audio directional enhancement and improving audio quality.

The feature information includes an amplitude difference feature and a phase difference feature, based on this, in an example, as shown in FIG. 7, the step S510 of performing feature extraction according to each channel of the audio frequency-domain signal to obtain the feature information may comprise steps S710 and S720.

S710 comprises extracting phase information of each channel of the audio frequency-domain signal of each microphone in a microphone array of a same hearing aid unit to obtain a phase difference feature.

In one example, a user wears the hearing aid device, such that the first hearing aid unit and the second hearing aid unit are respectively located on a left ear side and a right ear side of the user.

In some instances, the control chip may respectively obtain the phase difference feature of the same hearing aid unit based on the phase information of each channel of the audio frequency-domain signal of the first hearing aid unit and the phase information of each channel of the audio frequency-domain signal of the second hearing aid unit.

S720 comprises extracting amplitude information of each channel of the audio frequency-domain signal of each microphone in microphone arrays of different hearing aid units, to obtain an amplitude difference feature.

In some instances, the control chip may obtain the amplitude difference feature between different hearing aid units according to the amplitude information of each channel of the audio frequency-domain signal of the first hearing aid unit and the amplitude information of each channel of frequency-domain signal of the second hearing aid unit.

In one example, the phase information of each channel of the audio frequency-domain signal of each microphone in the microphone array of the same hearing aid unit is extracted to obtain the phase difference feature, and the amplitude information of each channel of the audio frequency-domain signal of each microphone in the microphone arrays of the different hearing aid units is extracted to obtain the amplitude difference feature. In the above method, the obtained feature information not only includes the phase difference feature of the same unit, but also includes the amplitude difference feature between different units, which improves richness of the feature information, and may correspondingly improve accuracy of a finally processed audio information.

In a case where each microphone array includes two microphones, in an example, as shown in FIG. 8, the step S710 of extracting the phase information of each channel of the audio frequency-domain signal of each microphone in the microphone array of the same hearing aid unit to obtain the phase difference feature may comprise steps S810-S830.

S810 comprises acquiring a phase difference between two channels of audio frequency-domain signals of the first hearing aid unit as a first feature.

In a case where each microphone array includes two microphones, each hearing aid unit may correspondingly obtain two channels of audio frequency-domain signals.

In some instances, the control chip may determine two channels of audio frequency-domain signals of the first hearing aid unit from each channel of the audio frequency-domain signal to acquire the phase difference between the two channels of audio frequency-domain signals as a first feature.

S820 comprises acquiring a phase difference between two channels of audio frequency-domain signals of the second hearing aid unit as a second feature.

In some instances, similarly, the control chip may determine the two channels of audio frequency-domain signals of the second hearing aid unit from each channel of the audio frequency-domain signal to acquire the phase difference between the two channels of audio frequency-domain signals as the second feature.

S830, comprises taking the first feature and the second feature as the phase difference feature.

In some instances, the control chip may take the obtained first feature and second feature together as the phase difference feature.

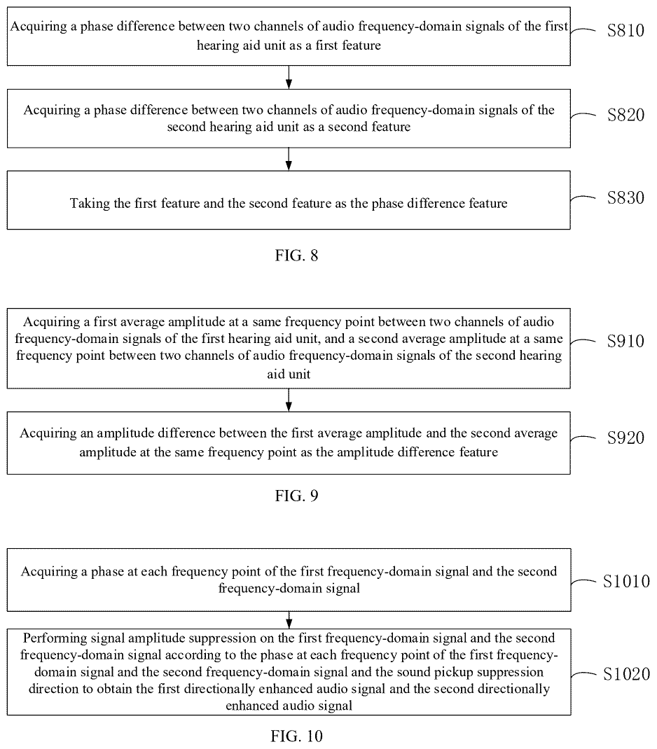

In the case where each microphone array includes two microphones, in an example, as shown in FIG. 9, the step S720 of extracting the amplitude information of each channel of the audio frequency-domain signal of each microphone in the microphone arrays of the different hearing aid units to obtain the amplitude difference feature may comprise steps S910 and S920.

S910 comprises acquiring a first average amplitude at a same frequency point between two channels of audio frequency-domain signals of the first hearing aid unit, and a second average amplitude at a same frequency point between two channels of audio frequency-domain signals of the second hearing aid unit.

In some instances, the control chip may determine the two channels of audio frequency-domain signals of the first hearing aid unit from each channel of the audio frequency-domain signal to acquire an average amplitude at the same frequency point between the two channels of audio frequency-domain signals, and to obtain the first average amplitude at each frequency point. Similarly, the control chip may determine the two channels of audio frequency-domain signals of the second hearing aid unit from each channel of the audio frequency-domain signal to acquire the average amplitude at the same frequency point of the two channels of audio frequency-domain signals, and obtain the second average amplitude at each frequency point.

S920 comprises acquiring an amplitude difference between the first average amplitude and the second average amplitude at the same frequency point as the amplitude difference feature.

In some instances, after obtaining the first average amplitude and the second average amplitude at each frequency point, the control chip may acquire the amplitude difference between the first average amplitude and the second average amplitude at the same frequency point as the amplitude difference feature.

In some examples, each microphone array includes two microphones. The phase difference between the two channels of audio frequency-domain signals of the first hearing aid unit is acquired as the first feature, the phase difference between the two channels of audio frequency-domain signals of the second hearing aid unit is acquired as the second feature, and the first feature and the second feature are taken as the phase difference feature. In addition, the first average amplitude at the same frequency point between the two channels of audio frequency-domain signals of the first hearing aid unit and the second average amplitude at the same frequency point between the two channels of audio frequency-domain signals of the second hearing aid unit are acquired to determine the amplitude difference between the first average amplitude and the second average amplitude at the same frequency point as the amplitude difference feature. In the above method, the phase difference of signals of the same hearing aid unit is acquired as the phase difference feature, and the amplitude difference between signals of different hearing aid units is acquired as the amplitude difference feature, which improves richness of the feature information.

A signal phase determines a signal direction. Based on this, in an example, as shown in FIG. 10, the step S630 of performing signal amplitude suppression in the sound pickup suppression direction on a first frequency-domain signal and a second frequency-domain signal separately to obtain the first directionally enhanced audio signal and the second directionally enhanced audio signal may comprise steps S1010 and S1020.

S1010 comprises acquiring a phase at each frequency point of the first frequency-domain signal and the second frequency-domain signal.

In some instances, after obtaining the fused first frequency-domain signal and second frequency-domain signal, the control chip may respectively acquire a phase at each frequency point of the first frequency-domain signal, and a phase at each frequency point of the second frequency-domain signal.

S1020 comprises performing signal amplitude suppression on the first frequency-domain signal and the second frequency-domain signal according to the phase at each frequency point of the first frequency-domain signal and the second frequency-domain signal and the sound pickup suppression direction, to obtain the first directionally enhanced audio signal and the second directionally enhanced audio signal.

Both the phase of the signal and the sound pickup suppression direction are represented by an angle.

In some instances, the control chip may separately match the phases of the first frequency-domain signal and the second frequency-domain signal with the sound pickup suppression direction, to perform signal amplitude suppression on the first frequency-domain signal according to a matching result to obtain the first directionally enhanced audio signal, and perform amplitude suppression on the second frequency-domain signal to obtain the second directionally enhanced audio signal.

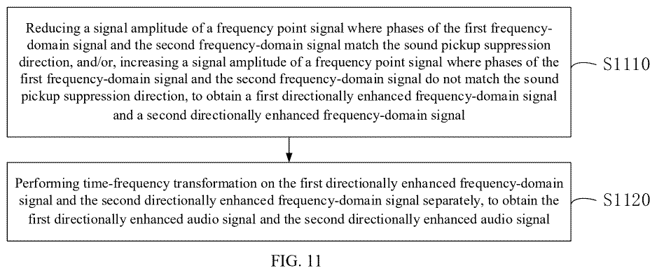

In an example, as shown in FIG. 11, the step S1020 of performing signal amplitude suppression on the first frequency-domain signal and the second frequency-domain signal according to the phase at each frequency point of the first frequency-domain signal and the second frequency-domain signal and the sound pickup suppression direction to obtain the first directionally enhanced audio signal and the second directionally enhanced audio signal may comprise steps S1110 and S1120.

S1110 comprises reducing a signal amplitude of a frequency point signal where phases of the first frequency-domain signal and the second frequency-domain signal match the sound pickup suppression direction, and/or increasing a signal amplitude of a frequency point signal where phases of the first frequency-domain signal and the second frequency-domain signal do not match the sound pickup suppression direction, to obtain a first directionally enhanced frequency-domain signal and a second directionally enhanced frequency-domain signal.

In some instances, for the first frequency-domain signal, the control chip may, according to a preset decreasing amplitude, reduce the signal amplitude of the frequency point signal where the phase of the first frequency-domain signal matches the sound pickup suppression direction to obtain the first directionally enhanced frequency-domain signal, or may, according to a preset increasing amplitude, increase the signal amplitude of the frequency point signal where the phase of the first frequency-domain signal does not match the sound pickup suppression direction, or may obtain the first directionally enhanced frequency-domain signal. The control chip may further, according to the preset decreasing amplitude, reduce the signal amplitude of the frequency point signal where the phase matches the sound pickup suppression direction, and at the same time, according to the preset increasing amplitude, increase the signal amplitude of the frequency point signal where the phase matches the sound pickup suppression direction, thereby obtaining the first directionally enhanced frequency-domain signal.

Correspondingly, for the second frequency-domain signal, the control chip may, according to a preset decreasing amplitude, reduce the signal amplitude of the frequency point signal where the phase of the second frequency-domain signal matches the sound pickup suppression direction, to obtain the second directionally enhanced frequency-domain signal. Alternatively, the control chip may, according to a preset increasing amplitude, increase the signal amplitude of the frequency point signal where the phase of the second frequency-domain signal does not match the sound pickup suppression direction to obtain the second directionally enhanced frequency-domain signal. The control chip may further, according to the preset decreasing amplitude, reduce the signal amplitude of the frequency point signal where the phase matches the sound pickup suppression direction, and at the same time, according to the preset increasing amplitude, increase the signal amplitude of the frequency point signal where the phase matches the sound pickup suppression direction, thereby obtaining the second directionally enhanced frequency-domain signal.

In some examples, the decreasing amplitude and the increasing amplitude may be represented by a percentage, and may be the same or different, and may be any numerical value of 0% to 100%. For example, both the decreasing amplitude and the increasing amplitude are 50%, and a user may set the decreasing amplitude and the increasing amplitude according to actual needs. For example, the user may send a control command carrying the decreasing amplitude and the increasing amplitude to the binaural hearing aid device through an input terminal, thereby realizing flexible setting of the decreasing amplitude/increasing amplitude.

S1120 comprises performing time-frequency transformation on the first directionally enhanced frequency-domain signal and the second directionally enhanced frequency-domain signal separately to obtain the first directionally enhanced audio signal and the second directionally enhanced audio signal.

In some instances, upon obtaining the first directionally enhanced frequency-domain signal and the second directionally enhanced frequency-domain signal, a computer device may perform time-frequency transformation on the first directionally enhanced frequency-domain signal to transform the first directionally enhanced frequency-domain signal from the frequency domain to the time domain, and obtain the first directionally enhanced audio signal. Similarly, the computer device may perform time-frequency transformation on the second directionally enhanced frequency-domain signal to transform the second directionally enhanced frequency-domain signal from the frequency domain to the time domain, and obtain the second directionally enhanced audio signal.

In an example of the present disclosure, by acquiring the phases of the first frequency-domain signal and the second frequency-domain signal, signal amplitude suppression is performed on the first frequency-domain signal and the second frequency-domain signal according to the phase at each frequency point of the first frequency-domain signal and the second frequency-domain signal and the sound pickup suppression direction to obtain the first directionally enhanced audio signal and the second directionally enhanced audio signal. Specifically, the signal amplitude of the frequency point signal where the phases of the first frequency-domain signal and the second frequency-domain signal match the sound pickup suppression direction may be reduced, and/or the signal amplitude of the frequency point signal where the phases of the first frequency-domain signal and the second frequency-domain signal match the sound pickup suppression direction is increased to obtain the first directionally enhanced frequency-domain signal and the second directionally enhanced frequency-domain signal, and time-frequency transformation is separately performed on the first directionally enhanced frequency-domain signal and the second directionally enhanced frequency-domain signal to obtain the first directionally enhanced audio signal and the second directionally enhanced audio signal. In the above method, a correlation relationship between the phase and direction is used to perform signal amplitude suppression/enhancement, which improves accuracy of a suppression/enhancement direction, and correspondingly improves direction accuracy of directional signal enhancement.

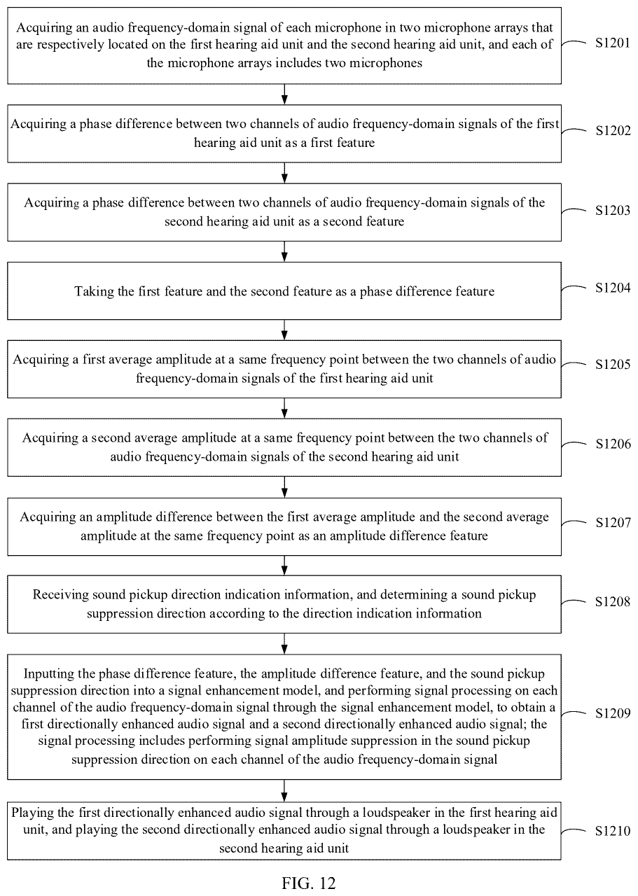

For ease of understanding of a person skilled in the art, the audio processing method provided by the present disclosure is described in detail below, as shown in FIG. 12, the method may include:
S1201: acquiring an audio frequency-domain signal of each microphone in two microphone arrays that are respectively located on the first hearing aid unit and the second hearing aid unit, and each of the microphone arrays includes two microphones;
S1202: acquiring a phase difference between two channels of audio frequency-domain signals of the first hearing aid unit as a first feature;
S1203: acquiring a phase difference between two channels of audio frequency-domain signals of the second hearing aid unit as a second feature;
S1204: taking the first feature and the second feature as a phase difference feature;
S1205: acquiring a first average amplitude at a same frequency point between the two channels of audio frequency-domain signals of the first hearing aid unit;
S1206: acquiring a second average amplitude at a same frequency point between the two channels of audio frequency-domain signals of the second hearing aid unit;
S1207: acquiring an amplitude difference between the first average amplitude and the second average amplitude at the same frequency point as an amplitude difference feature;
S1208: receiving sound pickup direction indication information, and determining a sound pickup suppression direction according to the direction indication information;
S1209: inputting the phase difference feature, the amplitude difference feature, and the sound pickup suppression direction into a signal enhancement model, and performing signal processing on each channel of the audio frequency-domain signal through the signal enhancement model, to obtain a first directionally enhanced audio signal and a second directionally enhanced audio signal; the signal processing includes performing signal amplitude suppression in the sound pickup suppression direction on each channel of the audio frequency-domain signal; and
S1210: playing the first directionally enhanced audio signal through a loudspeaker in the first hearing aid unit, and playing the second directionally enhanced audio signal through a loudspeaker in the second hearing aid unit.

It needs to be noted that, descriptions in the above steps S1201 to S1210 may refer to related descriptions in the above examples, and effects thereof are similar, which are not repeatedly described in the example herein.

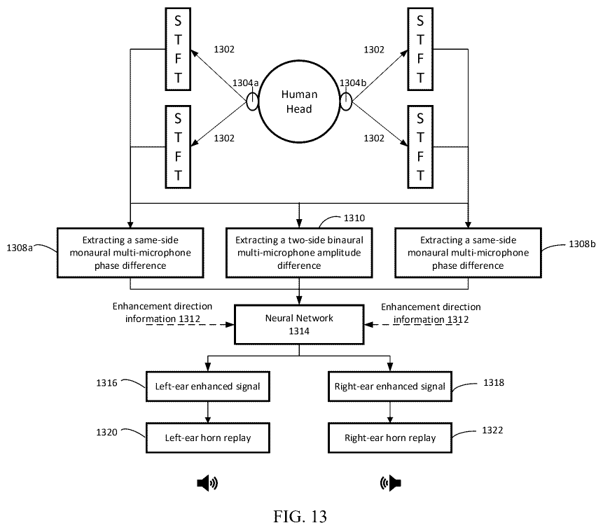

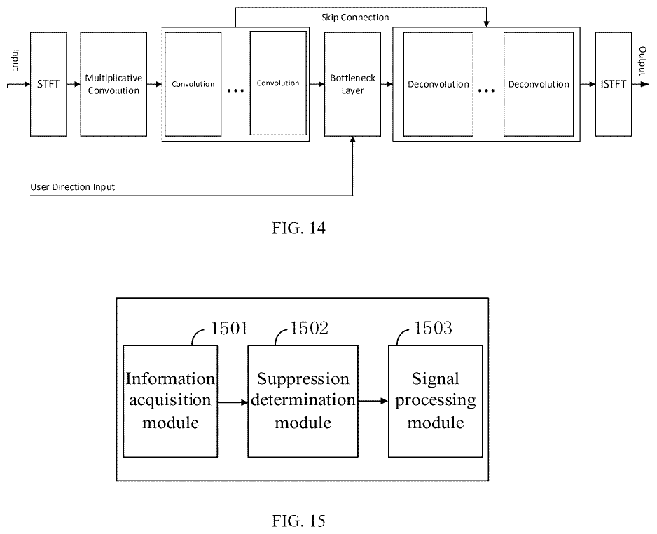

In some examples, the hearing aid device includes the first hearing aid unit and the second hearing aid unit, which are respectively disposed on a left ear side and a right ear side of a user. The first hearing aid unit and the second hearing aid unit both include a microphone array and a loudspeaker, and each of the microphone arrays includes two microphones. As shown in FIG. 13, the control chip in the hearing aid device may perform STFT 1302 on four channels of audio signals collected by the microphone array in the first hearing aid unit 1304a and the second hearing aid unit 1304b to obtain four channels of audio frequency-domain signals, extract the first feature and the second feature, that is, the phase difference (shown as a same-side monaural multi-microphone phase difference 1308a and 1308b in FIG. 13), and an amplitude difference feature (shown as a two-side binaural multi-microphone amplitude difference 1310 in FIG. 13), and meanwhile receive sound pickup direction indication information (shown as suppression direction information/enhancement direction information 1312 in FIG. 13) input by the user. The control chip inputs the above first feature, second feature, amplitude difference feature, and sound pickup direction indication information into a pre-trained signal enhancement model (shown as a neural network model 1314 in figure, with a structure as shown in FIG. 14), performs fusion and signal amplitude suppression on each channel of the audio frequency-domain signal, and obtains the first directionally enhanced audio signal (shown as a left-ear enhanced signal 1316 in FIG. 13) and the second directionally enhanced audio signal (shown as a right-ear enhanced signal 1318 in FIG. 13) through ISTFT. The control chip then replays the first directionally enhanced audio signal through the loudspeaker (shown as a left-ear horn 1320) in the first hearing aid unit, and replays the second directionally enhanced audio signal through the loudspeaker (shown as a right-ear horn 1322) in the second hearing aid unit.

It should be understood that, although the various steps in the flowcharts involved in the examples described above are displayed in the order indicated by the arrows, these steps are not necessarily performed in the order indicated by the arrows. Unless explicitly stated herein, there is no strict sequential restriction on the execution of these steps, and they may be performed in other orders. Furthermore, at least some of the steps in the flowcharts involved in the examples described above may include multiple steps or multiple stages, and these steps or stages are not necessarily completed at the same time but may be executed at different times. The execution order of these steps or stages is also not necessarily sequential but may alternate or interleave with at least part of other steps, or at least part of steps or stages in other steps.

Based on the same inventive concept, an example of the disclosure further provides an audio processing device configured to implement the audio processing method. The solution provided by the device for addressing the problem is similar to the solution described in the foregoing method. Therefore, the specific limitation of one or more examples of the audio processing device to be provided below may refer to the above limitation of the noise reduction method, and is not repeated here.

In an example, as shown in FIG. 15, an audio processing device is provided, including: an information acquisition module 1501, a suppression determination module 1502, and a signal processing module 1503, in which:
the information acquisition module 1501 is configured to acquire each channel of an audio frequency-domain signal of each microphone in two microphone arrays that are respectively located on the first hearing aid unit and the second hearing aid unit;
the suppression determination module 1502 is configured to receive sound pickup direction indication information, and determine a sound pickup suppression direction according to the sound pickup direction indication information; and
the signal processing module 1503 is configured to perform signal processing on each channel of the audio frequency-domain signal according to the sound pickup suppression direction to obtain a first directionally enhanced audio signal and a second directionally enhanced audio signal, in which the signal processing includes adjusting a signal amplitude according to the sound pickup suppression direction; the first directionally enhanced audio signal is played through the first hearing aid unit, and the second directionally enhanced audio signal is played through the second hearing aid unit.

All or part of the modules in the maintenance device of a print head may be implemented in software, hardware, or a combination of both. The above modules may be embedded in or independent of the processor of the computer device in a hardware form, or stored in the memory of the computer device in a software form, so that the processor can invoke and execute the operations corresponding to the above modules.

In an example, a hearing aid device is provided, including a first hearing aid unit, a second hearing aid unit, and a control chip; the first hearing aid unit and the second hearing aid unit both include a microphone array and a loudspeaker; and the control chip is configured to implement the steps of any one of the above audio processing methods.

In an example, a hearing aid system is provided, including an input terminal and the above hearing aid device that communicate with each other. The input terminal is configured to send sound pickup direction indication information input by a user to the hearing aid device, and the hearing aid device is configured to implement the steps of any one of the above audio processing methods.

In an example, a computer readable storage medium is provided, and a computer program is stored on the computer readable storage medium and implements the steps of any one of the above audio processing methods when executed by a processor.

In an example, a computer program product is provided, including a computer program that implements the steps of any one of the above audio processing methods when executed by a processor.

Those skilled in the art can understand that all or part of the processes in the above examples can be accomplished by instructing relevant hardware through a computer program. The computer program can be stored in a non-volatile computer-readable storage medium, and may include the processes of the examples of the above methods when executed. Any reference to memory, database, or other media used in the examples provided in the present disclosure may include at least one of non-volatile and volatile memories. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may include a random access memory (RAM) or an external cache memory, and the like. As an illustration and not a limitation, the RAM may take various forms, such as a static random access memory (SRAM) or a dynamic random access memory (DRAM), and the like. The databases involved in the examples provided in the present disclosure may include at least one of relational databases and non-relational databases. Non-relational databases may include distributed databases based on blockchain, but are not limited to these. The processors involved in the examples provided in the present disclosure may be general-purpose processors, central processing units, graphics processors, digital signal processors, programmable logic devices, quantum computing-based data processing logic devices, and the like, but are not limited to these.

The technical features of the above examples can be combined in any way. For conciseness of description, not all possible combinations of the technical features in the examples described above are described. However, these combinations should be within the scope of the description as long as no contradiction occurs in the combinations of these technical features.

The above examples represent only several examples of the present disclosure, which are described specifically in detail, but should not be construed thus as limitations on the scope of the present disclosure. It should be noted that several variations and improvements can be made without departing from the spirit of the disclosure for those skilled in the art, all of which fall within the scope of the present disclosure. Accordingly, the scope of the present disclosure should be subject to the appended claims.

What is claimed is:

1. An audio processing method applied to a hearing aid device comprising a first hearing aid unit and a second hearing aid unit, the method comprising:
acquiring one or more channels of an audio frequency-domain signal of each microphone in two microphone arrays that are respectively located on the first hearing aid unit and the second hearing aid unit;
receiving sound pickup direction indication information;
determining a sound pickup suppression direction according to the sound pickup direction indication information; and
adjusting, based on the sound pickup suppression direction, a signal amplitude of each of the one or more channels of the audio frequency-domain signal to obtain a first directionally enhanced audio signal and a second directionally enhanced audio signal; and
outputting the first directionally enhanced audio signal through the first hearing aid unit and the second directionally enhanced audio signal through the second hearing aid unit.

2. The method of claim 1, wherein adjusting the signal amplitude of each of the one or more channels of the audio frequency-domain signal to obtain the first directionally enhanced audio signal and the second directionally enhanced audio signal comprises:
performing fusion processing on each of the one or more channels of the audio frequency-domain signal of the first hearing aid unit to obtain a fused first frequency-domain signal;
performing fusion processing on each of the one or more channels of the audio frequency-domain signal of the second hearing aid unit to obtain a fused second frequency-domain signal; and
performing signal amplitude suppression in the sound pickup suppression direction on the fused first frequency-domain signal and the fused second frequency-domain signal separately to obtain the first directionally enhanced audio signal and the second directionally enhanced audio signal.

3. The method of claim 1, wherein adjusting the signal amplitude of each of the one or more channels of the audio frequency-domain signal according to the sound pickup suppression direction to obtain the first directionally enhanced audio signal and the second directionally enhanced audio signal comprises:
extracting features of each of the one or more channels of the audio frequency-domain signal to obtain feature information;
inputting the feature information and the sound pickup suppression direction into a signal enhancement model; and
performing signal processing on each of the one or more channels of the audio frequency-domain signal through the signal enhancement model to obtain the first directionally enhanced audio signal and the second directionally enhanced audio signal, wherein the signal enhancement model is a pre-trained neural network model.

4. The method of claim 3, wherein the feature information comprises an amplitude difference feature and a phase difference feature; and wherein extracting features of each of the one or more channels of the audio frequency-domain signal to obtain feature information comprises:
extracting phase information of each of the one or more channels of the audio frequency-domain signal of each microphone in a microphone array of a same hearing aid unit to obtain the phase difference feature; and
extracting amplitude information of each of the one or more channels of the audio frequency-domain signal of each microphone in the two microphone arrays of different hearing aid units to obtain the amplitude difference feature.

5. The method of claim 4, wherein each of the two microphone arrays comprises two microphones; and wherein extracting phase information of each of the one or more channels of the audio frequency-domain signal of each microphone in a microphone array of a same hearing aid unit to obtain the phase difference feature comprises:
acquiring a phase difference between two channels of audio frequency-domain signals of the first hearing aid unit as a first feature;
acquiring a phase difference between two channels of audio frequency-domain signals of the second hearing aid unit as a second feature; and
taking the first feature and the second feature as the phase difference feature.

6. The method of claim 4, wherein each of the two microphone arrays comprises two microphones; and wherein extracting amplitude information of each of the one or more channels of the audio frequency-domain signal of each microphone in the two microphone arrays of different hearing aid units to obtain the amplitude difference feature comprises:
acquiring a first average amplitude at a same frequency point between two channels of audio frequency-domain signals of the first hearing aid unit and a second average amplitude at the same frequency point between two channels of audio frequency-domain signals of the second hearing aid unit; and
acquiring an amplitude difference between the first average amplitude and the second average amplitude at the same frequency point as the amplitude difference feature.

7. The method of claim 4, wherein performing signal amplitude suppression in the sound pickup suppression direction on a first frequency-domain signal and a second frequency-domain signal separately to obtain the first directionally enhanced audio signal and the second directionally enhanced audio signal comprises:
acquiring a phase at each frequency point of the first frequency-domain signal and the second frequency-domain signal; and
performing signal amplitude suppression on the first frequency-domain signal and the second frequency-domain signal according to the phase at each frequency point of the first frequency-domain signal and the second frequency-domain signal and the sound pickup suppression direction to obtain the first directionally enhanced audio signal and the second directionally enhanced audio signal.

8. The method of claim 7, wherein performing signal amplitude suppression on the first frequency-domain signal and the second frequency-domain signal according to the phase at each frequency point of the first frequency-domain signal and the second frequency-domain signal and the sound pickup suppression direction to obtain the first directionally enhanced audio signal and the second directionally enhanced audio signal comprises:
reducing a signal amplitude of a frequency point signal where phases of the first frequency-domain signal and the second frequency-domain signal match the sound pickup suppression direction to obtain a first directionally enhanced frequency-domain signal and a second directionally enhanced frequency-domain signal; and
performing time-frequency transformation on the first directionally enhanced frequency-domain signal and the second directionally enhanced frequency-domain signal separately to obtain the first directionally enhanced audio signal and the second directionally enhanced audio signal.

9. A hearing aid device comprising;
a first hearing aid unit and a second hearing aid unit;
two microphone arrays respectively located on the first hearing aid unit and the second hearing aid unit, wherein the two microphone arrays are configured to acquire one or more channels of an audio frequency-domain signal;
a control chip configured to:
receive the one or more channels of an audio frequency-domain signal from each microphone of the two microphone arrays;
receive sound pickup direction indication information;
determine a sound pickup suppression direction according to the sound pickup direction indication information; and
adjust, based on the sound pickup suppression direction, a signal amplitude of each of the one or more channels of the audio frequency-domain signal to obtain a first directionally enhanced audio signal and a second directionally enhanced audio signal; and
two loudspeakers respectively located on the first hearing aid unit and the second hearing aid unit, wherein the two loudspeakers are each configured to output the first directionally enhanced audio signal through the first hearing aid unit and the second directionally enhanced audio signal through the second hearing aid unit.

10. The hearing aid device of claim 9, wherein the control chip is further configured to:
perform fusion processing on each of the one or more channels of the audio frequency-domain signal of the first hearing aid unit to obtain a fused first frequency-domain signal;
perform fusion processing on each of the one or more channels of the audio frequency-domain signal of the second hearing aid unit to obtain a fused second frequency-domain signal; and
perform signal amplitude suppression in the sound pickup suppression direction of the fused first frequency-domain signal and the fused second frequency-domain signal separately to obtain the first directionally enhanced audio signal and the second directionally enhanced audio signal.

11. The hearing aid device of claim 9, wherein the control chip is further configured to:
extract features of the one or more channels of the audio frequency-domain signal to obtain feature information;
input the feature information and the sound pickup suppression direction into a signal enhancement model; and
perform signal processing on each of the one or more channels of the audio frequency-domain signal through the signal enhancement model to obtain the first directionally enhanced audio signal and the second directionally enhanced audio signal, wherein the signal enhancement model is a pre-trained neural network model.

12. The hearing aid device of claim 11, wherein the feature information comprises an amplitude difference feature and a phase difference feature, and wherein the control chip is further configured to:
extract phase information from each of the one or more channels of the audio frequency-domain signal of each microphone in a microphone array of a same hearing aid unit to obtain the phase difference feature; and
extract amplitude information of each of the one or more channels of the audio frequency-domain signal of each microphone in the two microphone arrays to obtain the amplitude difference feature.

13. The hearing aid device of claim 11, wherein each of the two microphone arrays comprises two microphones and wherein the control chip is further configured to:
acquire a phase difference between two channels of audio frequency-domain signals of the first hearing aid unit as a first feature;
acquire a phase difference between two channels of audio frequency-domain signals of the second hearing aid unit as a second feature; and
take the first feature and the second feature as a phase difference feature.

14. The hearing aid device of claim 11, wherein each of the two microphone arrays comprises two microphones, and wherein the control chip is further configured to:
acquire a first average amplitude at a first frequency point between two channels of audio frequency-domain signals of the first hearing aid unit and a second average amplitude at a second frequency point between two channels of audio frequency-domain signals of the second hearing aid unit; and
acquire an amplitude difference between the first average amplitude and the second average amplitude at the same frequency point as an amplitude difference feature.

15. A hearing aid system comprising:
an input terminal and a hearing aid device configured to communicate with each other;
wherein the input terminal is configured to send sound pickup direction indication information to the hearing aid device; and
wherein the hearing aid device comprises one or more microphone arrays and is configured to:
receive one or more channels of an audio frequency-domain signal from each microphone of the one or more microphone arrays;
determine a sound pickup suppression direction according to the sound pickup direction indication information;
adjust, based on the sound pickup suppression direction, a signal amplitude of each of the one or more channels of the audio frequency-domain signal to obtain a first directionally enhanced audio signal and a second directionally enhanced audio signal; and
output the first directionally enhanced audio signal through a first hearing aid unit and the second directionally enhanced audio signal through a second hearing aid unit.

16. The hearing aid system of claim 15, wherein the hearing aid device comprises a first hearing aid unit and a second hearing aid unit and is further configured to:
perform fusion processing on each of the one or more channels of the audio frequency-domain signal of the first hearing aid unit to obtain a fused first frequency-domain signal;
perform fusion processing on each of the one or more channels of the audio frequency-domain signal of the second hearing aid unit to obtain a fused second frequency-domain signal; and
perform signal amplitude suppression in the sound pickup suppression direction of the fused first frequency-domain signal and the fused second frequency-domain signal separately to obtain the first directionally enhanced audio signal and the second directionally enhanced audio signal.

17. The hearing aid system of claim 15, wherein the hearing aid device is further configured to:
extract features of the one or more channels of the audio frequency-domain signal to obtain feature information;
input the feature information and the sound pickup suppression direction into a signal enhancement model; and
perform signal processing on each of the one or more channels of the audio frequency-domain signal through the signal enhancement model to obtain the first directionally enhanced audio signal and the second directionally enhanced audio signal, wherein the signal enhancement model is a pre-trained neural network model.

18. The hearing aid system of claim 17, wherein the feature information comprises an amplitude difference feature and a phase difference feature and the hearing aid device is further configured to:
extract phase information from each of the one or more channels of the audio frequency-domain signal of each microphone of the one or more microphone arrays to obtain the phase difference feature; and
extract amplitude information of each of the one or more channels of the audio frequency-domain signal of each microphone of the one or more microphone arrays to obtain the amplitude difference feature.

19. The hearing aid system of claim 17, each of the one or more microphone arrays comprises two microphones and wherein the hearing aid device is further configured to:
acquire a phase difference between two channels of audio frequency-domain signals of the first hearing aid unit as a first feature;
acquire a phase difference between two channels of audio frequency-domain signals of the second hearing aid unit as a second feature; and
take the first feature and the second feature as a phase difference feature.

20. The hearing aid system of claim 17, wherein the hearing aid device comprises a first hearing aid unit and a second hearing aid unit each, wherein each of the one or more microphone arrays comprises two microphones, and wherein the hearing aid device is further configured to:
acquire a first average amplitude at a first frequency point between two channels of audio frequency-domain signals of the first hearing aid unit and a second average amplitude at a second frequency point between two channels of audio frequency-domain signals of the second hearing aid unit; and
acquire an amplitude difference between the first average amplitude and the second average amplitude at the same frequency point as an amplitude difference feature.
